(19) United States
(12) Patent Application Publication
(10) Pub. No.: US 2003/0015591 A1
(43) Pub. Date: Jan. 23, 2003

(54) Transmissive apparatus and method for optically sensing relative torque employing moire fringes

(76) Inventor: Bo Su Chen, Garland, TX (US)

Correspondence Address: HONEYWELL INTERNATIONAL INC., 101 COLUMBIA ROAD, P O BOX 2245, MORRISTOWN, NJ, 07962-2245, US

(21) Appl. No.: 09/907,364

(22) Filed: Jul. 17, 2001

(51) Int. Cl. G06K 19/06

(52) U.S. Cl. 235/494

(57) ABSTRACT

An apparatus and method for analyzing the performance of a system having at least one rotating member therein are disclosed. Light is directed from a light source to intercept an encoded portion of the rotating member. A portion of the light is transmitted from the encoded portion of the rotating member. The transmitted portion of the light can be then detected to recover performance information maintained therein, wherein the performance information contains performance characteristics of the system. A mechanism for transmitting a portion of the light from the encoded portion of the rotating member is also provided. A diffracted portion of the light can be detected to recover performance information. The light source can be configured as a vertical cavity surface emitting laser (VCSEL). The encoded portion of rotating members thereof may comprise a dual layer bar code. Images from a first encoded surface may interact with an image from a second encoded surface after the light beam is transmitted through the second rotating surface to produce Moirè fringes.

### RELATED APPLICATION

This application is related to co-pending and co-owned application entitled: “Reflective Apparatus and Method for Optically Sensing Relative Torque Employing Moirè Fringes” filed on even date herewith.

### FIELD OF THE INVENTION

The present invention is generally related to measuring methods and systems. The present invention is also related to optical measuring methods and systems. In addition, the present invention is related to methods and systems for measuring the angular displacement and relative torque between two rotating shafts. The present invention is additionally related to non-invasive optical measuring techniques. The present invention is also related to optically sensing techniques for measuring relative mechanical characteristics between rotating members within a system.

### BACKGROUND OF THE INVENTION

Torque Sensors

A variety of techniques for measuring torque in mechanical systems have been attempted. To date, however, none of these techniques has been completely satisfactory. Several methods of measuring torque within a shaft, strain or optical gauge have been described in the literature. As explained herein, such measuring techniques are generally limited in their scope and applications and are inherently unreliable in both their efficiency and accuracy.

Torque can be accurately measured in a shaft by bonding strain gauges in a cross arrangement along helical lines of compression and tension. The strain gauges can be electronically configured via a balance-bridge and coupled to measuring electronics through slip rings or non-contacting rotary transformers. Generally, these cross arrangements are difficult to implement and usually require custom installation.

In optical torque transducers light beams, code patterns and light sensors convert the differential angular displacement between two positions on a shaft into an output signal, due to applied torque. Specifically, identical patterns made of light-reflecting strips can be arranged around the circumference of the shaft at two locations. The patterns may be illuminated by laser diodes and the reflected light sensed by a photocell. The output of each photocell can be configured as a pulse train. The phase difference may be a measure of the torque. In a similar device, which is taught by Kawamoto, U.S. Pat. No. 4,767,925, Optical Type Relative Rotation Measurement Apparatus, a pair of light emitting and receiving elements produce an output dependent on the amount of light transmitted due to the relative rotation of two slotted disks. Levine, U.S. Pat. No. 4,433,585, Device for Measurement of the Torsional Angular Deviation of a Loaded Rotating or Static Shaft, discloses a technique for passing a beam of light through two diffraction gratings placed at different locations along a shaft and sensing the phase of the two resulting beams. Such techniques and devices thereof are not robust because they require exact alignment for optimal functioning.

U.S. Pat. No. 5,001,937, Optically Based Torsion Sensor, to Bechtel et al., discloses an optically-based torsion sensor that measures the phase displacement between two bands of alternating high and low reflectivity regions. A major drawback of this device is its dependence on the initial alignment of the two bands. In addition, minor differences in the rise time of detecting electronics will cause serious errors in measurement. U.S. Pat. No. 4,525,068, Torque Measurement Method and Apparatus, to Mannava et al., discloses a torque sensor utilizing optical Doppler measurements. The device of Mannava et al. suffers from a serious shortcoming in that it must infer torque from changes in instantaneous rotational velocity of two different sections of a shaft.

Two optical methods for measuring the strain of an object are noteworthy. U.S. Pat. No. 4,939,368, Polychromatic Optical Strain Gauge, to Brown, discloses an optical grating to measure strain in a stationary object. The device is complicated in that it requires two frequencies of light and has no provision for measuring a moving object, such as a rotating shaft. U.S. Pat. No. 4,432,239, Apparatus for Measuring Deformation, to Bykov, discloses an apparatus for measuring the deformation of an object. The device utilizes an electro-optical frequency modulator to produce two components from an incident laser beam. A polarization splitter further splits the light into two different frequencies, which illuminate a diffraction grating on a stationary object. This device is also complicated and expensive and has no provision for measurement of a moving object such as a rotating shaft.

The literature discloses a capacitive torque sensor consisting of two encoders either mounted perpendicular to the shaft at each end or mounted along the circumference at two closely placed points along the shaft. For example, see Interest in Misfire Detection Technology Grows, Automotive Electronics Journal, Nov. 6, 1989, pg 12. Each encoder has two parts: a stator, which consists of up to 256 radial fingers that are alternately charged, and a rotor, which is generally mounted on the shaft. As the shaft turns, the rotor's potential switches between positive and negative at a frequency proportional to speed. A disk, in the center of the stator, electrically isolated from the charged fingers, collects the signal. Like the optical torque sensor, the twist of the shaft may be determined by measuring the phase difference between the two encoders. Also like the optical sensor, this device requires exact alignment.

Finally, magnetic torque sensors comprise much of the prior art. The magnetic properties of most ferromagnetic materials change with the application of stress to such an extent that stress may be ranked with field strength and temperature as one of the primary factors affecting magnetic charge. Magnetostriction is a measure of the stress sensitivity of a material's magnetic properties. Magnetic-based torque sensors take advantage of the magnetostrictive properties of ferromagnetic metals, such as carbon steel. See Noncontact Magnetic Torque Transducer, Sensors, November 1990, pgs. 37-40. These sensors make a contact-less measurement of changes of magnetic permeability in shaft materials, which are caused by torsional stress.

In place of strain gauges, magnetic flux may be directed into the shaft and along the helical lines of compression and tension. A positive magnetostriction shaft experiencing torsion will exhibit increased permeability along the line of tension and decreased permeability along the line of compression. At low stress levels the permeability is nearly linear with stress but varies dramatically at high stress. Another drawback of a magnetostrictive torque sensor is the need for calibrating it individually with each shaft. This requirement is obvious because the torque measurement is made by means of the magnetostrictive properties of the shaft material and cannot be predetermined in the manufacture of the sensor by itself.

The variability in magnetostrictive properties is usually correlated with the variability of the mechanical hardness of the material. Hardness variability of shaft materials typically ranges from +10% to +40%. The shaft-to-shaft variability problem has been addressed in recent research by adding either a sleeve or coating of a well-defined and magnetically soft material, such as nickel, permalloy, or ferromagnetic amorphous alloys. While this approach shows promise, installation can not be made in situ, and all magnetic materials, even the softest, can retain some magnetism, leading to non-linearities and drift.

Each of the above-mentioned techniques for measuring torque falls short of the ideal due to a variety of shortcomings, including high cost, inadequate resolution and sensitivity, extreme dependence on precise alignment, inability to be applied in situ, or susceptibility to environmental conditions. Therefore, there exists a need for an economical, accurate, simple, non-contact sensor for the measurement of relative torque.

Moirè Fringes and Talbot Self-image Effect

When electromagnetic rays are impinged and reflected off a patterned surface, such as a diffraction grating, a grooved surface or a bar code, the reflected rays form an image of the grooves or pattern of the patterned surface. When reflected electromagnetic rays from two such surfaces are subsequently made to interact, the resulting pattern may be an interaction of the two patterns, which is the super-position, interaction or interference of the two simple harmonic functions. In classical optics these patterns are generally known as Talbot interferograms, Fresnel patterns or Moirè fringes. See The Handbook of the Moirè Fringe Technique, K. Patorskii (1993). Similar Moirè fringes and Talbot self-image effect can be observed when a single beam of light is transmitted through two gratings or bar codes placed on top of each other. For detailed mathematical theory on the Talbot self-image effect see Introduction to Fourier Optics, by J. W. Goodman, 2^{nd} Ed., pgs. 87-89.

Moirè fringes and the Talbot self-image effect have hitherto been used effectively in a multitude of applications, including anti-counterfeiting devices, determination of optical characteristics of manufactured lenses, calibration of screen printing devices, etc. A review of the literature reveals that Moirè fringes and the Talbot self-image effect have hitherto not been applied to sensors for the measurement of the relative torque between two rotating shafts.

### SUMMARY OF THE INVENTION

One aspect of the present invention provides for a measuring method and apparatus.

Another aspect of the present invention provides for an optical measuring method and apparatus.

A further aspect of the present invention provides for a method and apparatus for measuring the angular displacement and relative torque between two rotating shafts.

An additional aspect of the present invention provides optical sensing techniques for measuring relative mechanical characteristics between rotating members within a mechanical system.

An additional aspect of the present invention provides for the utilization of vertical cavity surface-emitting laser (VCSEL) diodes.

The above and other aspects of the present invention are achieved as is now described. An optical angular displacement sensor is utilized to measure rotary displacement between two or more shafts, which rotate together. By connecting the shafts together utilizing a torsion bar, the sensor can be used to measure transmitted torque. The sensor generally comprises first and second transparent coaxial discs mounted on shafts, which have encoded surfaces adhered or affixed to their planar surfaces. The encoded surfaces are adhered to the disks in such a way that they face each other in the gap between the two rotating disks. The apparatus operates by transmitting a beam of light through the encoded surfaces adhered to the planar surfaces of the two mounted disks on the rotating shafts.

The light beam can be incident upon the encoded surface of the first rotating disk at a perpendicular angle of incidence, i.e., parallel to the rotational axis of the disks. The image of the encoded pattern from the transmitted beam of light from the first disk interacts with the encoded pattern of the second disk as the beam is transmitted through it. By virtue of the design of the encoded surfaces, the transmitted beam of light forms Moirè fringes that are dynamically stable when the two rotating shafts rotate synchronously.

When the rotating shafts rotate asynchronously, the Moirè fringes exhibit motion that can be detected. The detected signal can be analyzed to yield a variety of relative mechanical characteristics of the rotating shafts, including the relative torque between the shafts. Contrast within the Moirè fringes is significantly improved by placing the detector at the Talbot distance.

In addition to measuring angular displacement and torque, the apparatus can also be configured to measure performance characteristics such as relative spring and damping coefficients, relative slip and friction, or relative uniformity of motion between the rotating shafts. The apparatus can also be used to determine the direction of rotation and extent of linear motion between the rotating shafts. Finally, the apparatus and method disclosed herein according to the present invention can be utilized to provide feedback to the mechanical system to improve performance and reliability.

### BRIEF DESCRIPTION OF DRAWINGS

FIG. 1 illustrates a flow diagram illustrating basic operations of an optical torque sensor, in accordance with a preferred embodiment of the present invention;

FIG. 2 depicts a side sectional view of an optical torque sensor, in accordance with a preferred embodiment of the present invention;

FIG. 3 illustrates an overall schematic layout of an optical torque sensor illustrated in FIG. 2, in accordance with a preferred embodiment of the present invention;

FIG. 4 is a diagram illustrating functioning of the encoded surfaces for the generation of Moirè fringes, in accordance with a preferred embodiment of the present invention;

FIG. 5 depicts a diagram illustrating the formation of Moirè fringes, in accordance with a preferred embodiment of the present invention; and

FIG. 6 is a graphical illustration of the relationship between the interaction angle of the bar codes of the encoded surfaces and the pitch of the Moirè fringes, in accordance with the present invention.

### DESCRIPTION OF PREFERRED EMBODIMENTS

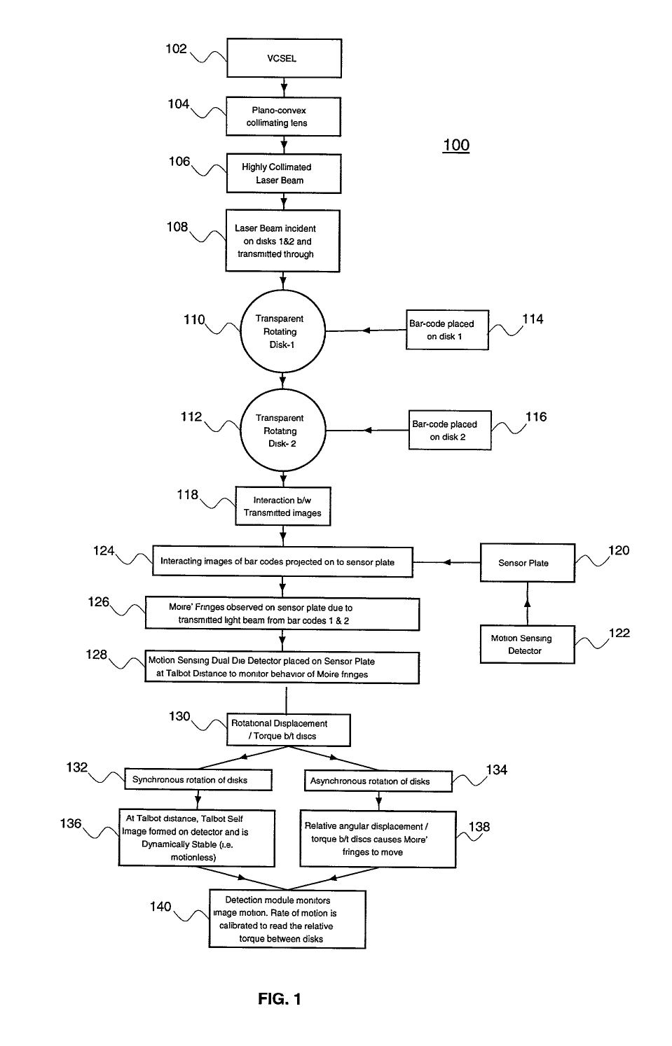

Referring to FIG. 1, a flow diagram 100 illustrating basic functional operations of an optical torque sensor in a transmissive configuration is illustrated, in accordance with a preferred embodiment of the present invention. The optical torque sensor referred to in the flow diagram of FIG. 1 relies in part on the formation of Moirè fringes to detect relative torque. Such an optical sensor relies in part on the Talbot self-image effect. Those skilled in the art will appreciate that the flow diagram illustrated in FIG. 1 provides general operational steps in accordance with the present invention. It is anticipated that a thorough understanding of the invention may be realized by referring to the other figures presented herein.

Thus, as illustrated at block 102, a single (although more than one is possible) vertical cavity surface emitting laser (VCSEL) unit is the source of a beam of uncollimated laser light. The VCSEL is one type of light source that can be utilized in accordance with the present invention. Other types of light sources can also be utilized in accordance with the present invention. For example, the light source can be configured as other types of lasers, a light-emitting diode, or an incandescent lamp. The uncollimated laser light is emitted in the form of an uncollimated laser beam. As depicted at block 104, the uncollimated laser beam passes through a convex lens, which renders the laser beam highly parallel, i.e., collimated, as illustrated thereafter at block 106. Thus, light beams from the VCSEL unit are rendered highly collimated by a convex lens before the light beam intercepts encoded portions of first and second rotating members (e.g., rotating disks 110 and 112) in accordance with the present invention.

The collimated laser beam is incident on, for example, two rotating disks. Thus, as depicted at blocks 110 and 112, the collimated laser beam can be incident respectively on a first disk and on a second disk each at a small angle of incidence “a”. For example, 90° to the plane of rotation can be used. As indicated at block 114, a bar-code was previously placed (for example, as a vernier) on transparent rotating disk 1 (i.e., the first disk). Likewise, as illustrated at block 116, a bar code was previously placed on transparent rotating disk 2 (i.e., the second disk). Such bar codes together form a dual layer bar code. Those skilled in the art can appreciate that the rotating disks discussed herein represent one form of a rotating member that may be utilized in accordance with the present invention. Other types of rotating members may also be utilized in accordance with the present invention. Examples of such a rotating member include a gear, a shaft, a linkage, etc.

As indicated at block 118, the image of the first bar code interacts (e.g., overlaps) with the image of the second bar code as the beam of light is transmitted through the rotating disks. As illustrated at block 124, the transmitted image is projected onto a sensor plate. As illustrated next at block 126, Moirè fringes can be observed on the sensor plate 120 due to the transmitted light beam emitted from first and second encoded surfaces associated respectively with the first and second disks described above. Thereafter, as depicted at block 128 a motion sensing dual die detector is placed on the sensor plate-120 at a Talbot distance to monitor the behavior of the Moirè fringes. As indicated at blocks 122 and 120, however, a motion sensing detector can be previously linked to the sensor plate.

Two paths of operational behavior are encountered at this point in the process. As illustrated at block 130, rotational displacement (i.e., angular displacement) and torque may be evidenced between the rotating disks. Either synchronous or asynchronous rotation of the disks may be evidenced, as indicated respectively at blocks 132 and 134, respectively.

If synchronous rotation is evidenced, as indicated at block 132, then as indicated at block 136, at the Talbot distance, a Talbot self-image is formed on the motion sensing detector indicating dynamic stability (i.e., motionless). The detection module (i.e., a detector or detection mechanism) can then monitor image motion, as illustrated at block 140. The detection module can be configured to translate motion within the Moirè fringes into angular displacement between the rotating disks, which in turn can be extrapolated to provide a measurement of the relative torque between the disks. Note that the detection module may also be referred to as a “detection mechanism” or a “detector mechanism.”

If asynchronous motion of the disks is evidenced, as indicated at block 134, then, as illustrated thereafter at block 138, the relative angular displacement and/or torque between the disks will cause the Moirè fringes to move. Thereafter, as described at block 140, the detection module monitors image motion. The rate of motion can be extrapolated by the detection module to read the relative torque between the disks.

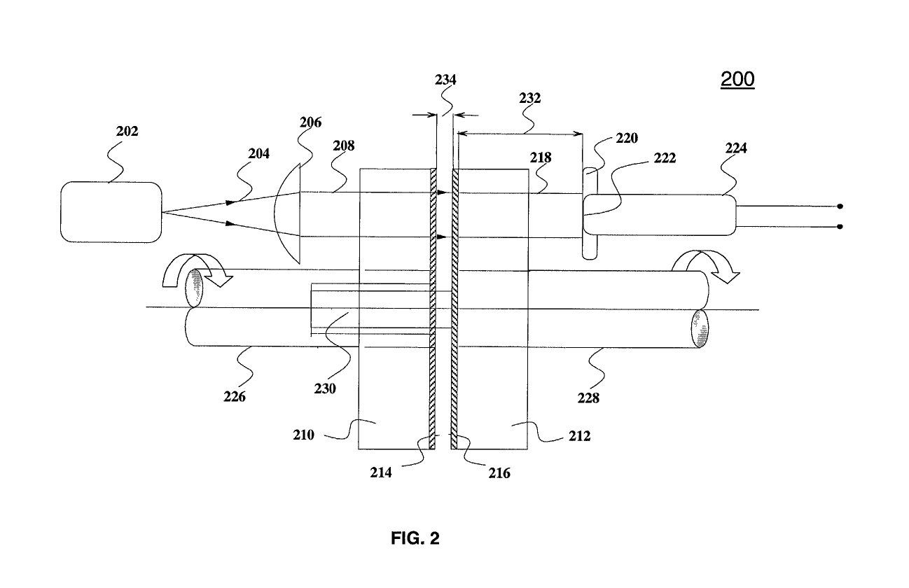

FIG. 2 depicts a side sectional view 200 of an optical torque sensor, in accordance with a preferred embodiment of the present invention. According to FIG. 2, a single vertical cavity surface emitting laser (VCSEL) unit 202 is the source of a single uncollimated laser light beam 204. Those skilled in the art will realize that one or more VCSEL sources or arrays of VCSEL sources can be used, depending on the application. The uncollimated laser light beam 204 is passed through a convex lens 206, which renders the laser beam highly parallel (i.e., collimated). After passing through convex lens 206, the collimated light beam 208 then serially impinges on rotating disk 210 at an angle of incidence of, for example, 90° with respect to the plane of rotation. In a preferred embodiment of the present invention, an input shaft 226 and an output shaft 228 are coupled together via a torsion bar 230 that is mounted coaxially (i.e., along the central axis of the mechanical system) and between the input 226 and output 228 shafts as illustrated in FIG. 2. Torque and rotational forces are transmitted from the input shaft 226 through the torsion bar 230 to the output shaft 228. Rotating disk 210 may be coaxially aligned and mounted at the end of the torque transmitting input shaft 226. Rotating disk 212 may be coaxially aligned and mounted at the end of the torque-receiving output shaft 228 facing input shaft 226 as shown in FIG. 2. The axes of rotation for the disks 210 and 212 are generally co-linear to the axes of rotation of the input 226 and output 228 shafts. As illustrated in FIG. 2, rotating disks 210 and 212 can be separated by a small gap 234 of between, for example, two and ten millimeters or some other spacing depending on the application. Rotating disks 210 and 212 are connected by springs or similar means (not shown).

In a preferred embodiment of the present invention, each of the rotating disks 210 and 212 have respective identical encoded patterns (e.g., bar codes) 214 and 216 applied to their planar surfaces as illustrated in FIG. 2. To achieve the formation of Moirè fringes, the collimated laser light beam 208 impinges on rotating disks 210 and 212, respectively. In a preferred embodiment, the laser beam 208 is first transmitted through disk 210 to form an image of the encoded pattern 214 on the encoded pattern 216 prior to transmission of light beam 208 through disk 212. As light beam 208 is transmitted through disk 212, it also acquires the encoded pattern from 216. These encoded patterns within the transmitted beam then interact to form Moirè fringes on the sensor plate 220. The sensor plate 220 is preferably placed at the Talbot distance 232 from the point where the beam of transmitted light leaves the edge of the encoded surface 216 as shown in FIG. 2. When the distance between the point of exit of the beam 218 from the encoded surface 216 and the sensor plate 220 is equal to the Talbot distance 232, exact replicas of encoded patterns 214 and 216 can be observed on sensor plate 220. This type of image is called a Talbot self-image.

The Talbot distance 232 in the above embodiment is mathematically represented by the following equation:

Z=2nL²/λ (Eq. 1)

where

z is the Talbot distance;

n is an integer;

L is the pitch P of the bar code; and

λ is the wave length of the light beam.

Thus, for example, for a bar code with 300 lines per inch, the pitch P is equal to 169.3 microns. If the incident light beam has a wave length A of 850 nanometers, and n is assumed to be 1, then the Talbot distance is equal to 1.6867 centimeters.

The Talbot self-image effect increases the contrast of the Moirè fringes. Such an increase in contrast improves the resolution, thereby enabling better and more efficient detection. In a preferred embodiment of the present invention, the sensor plate 220 is a dual die photo detector that measures the intensity of the light patterns that are incident upon it. Therefore, in the preferred embodiment it is preferable to maximize the intensity of the Moirè fringes and Talbot self-image. The mathematical relationship for the intensity distribution of Talbot self-image effect is represented as follows:

I(x,y)=¼[1+2m cos(πλz/L²)cos(πλx/L)+m² cos²(πλx/L)] (Eq. 2)

where

x,y,z represent the three Cartesian coordinates. The distance z represents the distance 232 between the bottom of the second encoded surface 216 and the top of the sensor plate 220. The x and y coordinates represent the two-dimensional plane of the sensor plate 220 where the Moirè fringes are projected;

m is the modulation coefficient. When m=1, maximum modulation occurs;

L is the period of the lines on the encoded surfaces 214 and 216, which are identical; and,

λ is the wavelength of the light beam.

The intensity, or conversely the contrast, of the Moirè fringes could be computed for different values for z. For example, the mathematical equation for z at the Talbot distance is z=2nL²/λ, where n is an integer. When this value of z is incorporated into the intensity distribution equation (2), it is thus reduced to the following:

I(x,y)=¼[1+2m cos(πλx/L)+m² cos²(πλx/L)]

or, when m=1

I(x,y)=¼[1+2 cos(πλx/L)+cos²(πλx/L)] (Eq. 3)

At a distance that is greater than the Talbot distance, at say z=(2n+1)L²/λ, the intensity distribution equation (2) is thus reduced to the following:

I(x,y)=¼[1−2m cos(πλx/L)+m² cos²(πλx/L)]

or, when m=1

I(x,y)=¼[1−2 cos(πλx/L)+cos²(πλx/L)] (Eq. 4).

At a distance that is less than the Talbot distance, at say z=(n−½)L²/λ, the intensity distribution equation (2) is thus reduced to the following:

I(x,y)=¼[1+m² cos²(πλx/L)]

or, when m=1

I(x,y)=¼[1+cos²(πλx/L)] (Eq. 5)

Those skilled in the art can appreciate that by solving equations (3), (4) and (5) by including the empirical values for the various variables within these equations, the intensity distribution is the maximum for equation (3), i.e., at the Talbot distance. Therefore, at the Talbot distance exact replicas of the two encoded surfaces would be formed on the sensor plate 220 which are of the greatest intensity possible. This feature of the preferred embodiment improves the resolution and at the same time decreases the demand for high resolution optics.

It is noteworthy that the Moirè fringes and Talbot self-images are observed in all modes of operation of the mechanical system, i.e., when both shafts 226 and 228 are stationary, or when both shafts 226 and 228 rotate either synchronously or asynchronously. Preferably, when no torque is applied between the input and output shafts 226 and 228, the Moirè fringes that are formed remain dynamically stable, i.e., without any motion. When torque is applied between input and output shafts 226 and 228, the torsion bar 230 can be subject to torsional forces that cause the input end to have a certain angular displacement relative to the output end of the torsion bar 230. This in turn causes a relative angular displacement between disks 210 and 212. When the relative rotation between disks 210 and 212 is asynchronous, Moirè fringes are formed that move parallel to the plane of rotation. The direction of motion of the Moirè fringes is dependent upon the direction of rotation of the shafts. When the direction of motion reverses, the Moirè fringes move in the opposite direction.

Additionally, the direction of motion of the Moirè fringes can be dependent upon the displacement between the disks 210 and 212. Therefore, detection module 222 (discussed below) can also be configured to detect the torque direction as well as angular displacement. Also, if one of the disks 210 or 212 is fixed (or held stationary), detection module 222 can be utilized to measure the rate of rotation of the other.

Additionally, the Talbot self-image is formed by interaction of the images of the bar codes from all of the elements from encoded patterns 214 and 216, and the Moirè pattern thus formed is a combination effect created by all elements of the Talbot self-images. Thus, the output from detection module 222 is not sensitive to changes from local defects on the surface of the encoded surfaces. Had the performance of the sensor been susceptible to minor defects on the encoded surfaces, expensive enveloping apparatus would have been required to safeguard against any damage to the encoded surfaces. The relative insensitivity to minor defects in the encoded surfaces makes the apparatus more robust and further reduces the cost of the apparatus.

In a preferred embodiment of the present invention, any motion of the Moirè fringes is monitored by detection module 222, which comprises dual die detectors. Those skilled in the art can appreciate that the spacing between the two detection components of the dual die detectors can be designed in such a manner as to introduce a phase shift (e.g., 90°). This phase shift can be introduced by the spacing utilized to detect the direction of motion of the Moirè fringes. Detection module 222 is programmed to translate the motion within the Moirè fringes into angular displacement between disks 210 and 212, which in turn provides a measurement for the relative torque between the disks 210 and 212. In the preferred embodiment, photo detectors commonly used in the art have been employed and, therefore, not described in detail.

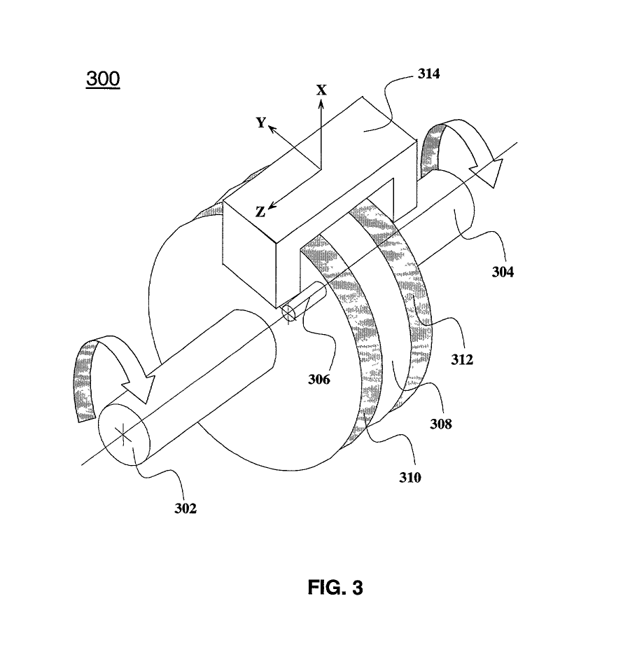

FIG. 3 illustrates an overall schematic layout 300 of an optical torque sensor, in accordance with a preferred embodiment of the present invention.

Torque from the input shaft 302 is transmitted to the output shaft 304 through the torsion bar 306. The rotating disks 310 and 312 are attached to the facing ends of the input and output shafts 302 and 304. The two rotating disks are separated by a small distance 308. The housing of the light source and the detection module are illustrated in the housing module 314. Because the bar codes are relatively insensitive to minor defects or damage, the housing does not have to be air tight, thereby reducing both the cost of fabrication and maintenance of the apparatus.

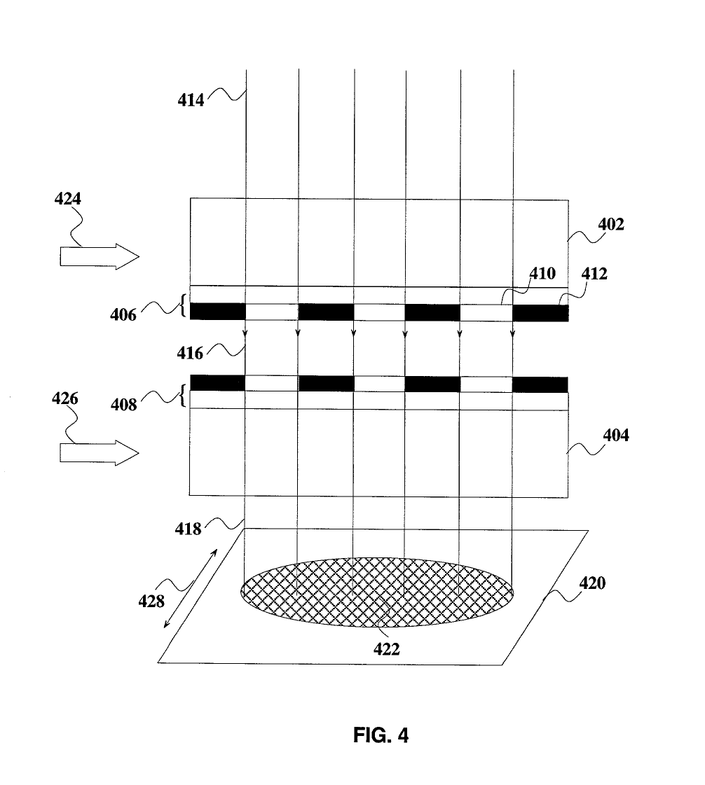

FIG. 4 is a diagram illustrating functioning of the encoded surfaces in accordance with a preferred embodiment of the present invention. A magnified view of the rotating disks is depicted by blocks 402 and 404. The encoded surface 406 is preferably adhered to the face of disk 402 facing the disk 404. Similarly the encoded surface 408 is preferably adhered to the face of the rotating disk 404 that is facing disk 402. Block 412 is a cross sectional view of one of the lines of the bar code 406. Block 410 is a cross sectional view of the gap between one line of bar code 412 and the next line of the encoded surface (406, 408). The combined width of 410 and 412 is the pitch of the bar code 406.

The collimated laser beam 414 is transmitted through disk 402 and passes through the bar code 406. The opaque lines, i.e., 412, of the bar code 406 prevent light from the laser beam 414 from being transmitted through the bar code. The transparent gap between the successive lines of bar code, i.e., 410, allows the laser beam 414 to pass through unimpeded. The resulting beam 416 transmitted through the rotating disk 402 carries an image of the bar code 406. This transmitted beam 416 then passes through the bar code 408. Again, the opaque lines of the bar code 408 prevent the transmission of light, while the transparent areas between the lines of the bar code 408 allow the passage of the light beam 416. As the light beam 416 passes through the bar code 408, it carries with it an image of the bar code 408. Therefore, the resultant transmitted beam 418 carries the images of both encoded surfaces (e.g., bar codes) 406 and 408.

The transmitted beam 418 is projected on to the sensor plate 420 at substantially a 90° angle to the surface of the sensor plate. The images of the encoded surfaces 406 and 408 contained in the transmitted beam 418 interact to form Moirè fringes 422 that are observed on the sensor plate 420.

The rotating disks 402 and 404 rotate in the direction indicated by arrows 424 and 426. If the rotating disks 402 and 404 are both stationary, or both rotating synchronously, the Moirè fringes 422 remain stable (i.e., motionless). If the rotation of the disks 402 and 404 is asynchronous, the Moirè fringes 422 begin to move in an angle perpendicular to the direction of motion of the disks as shown by arrow 428.

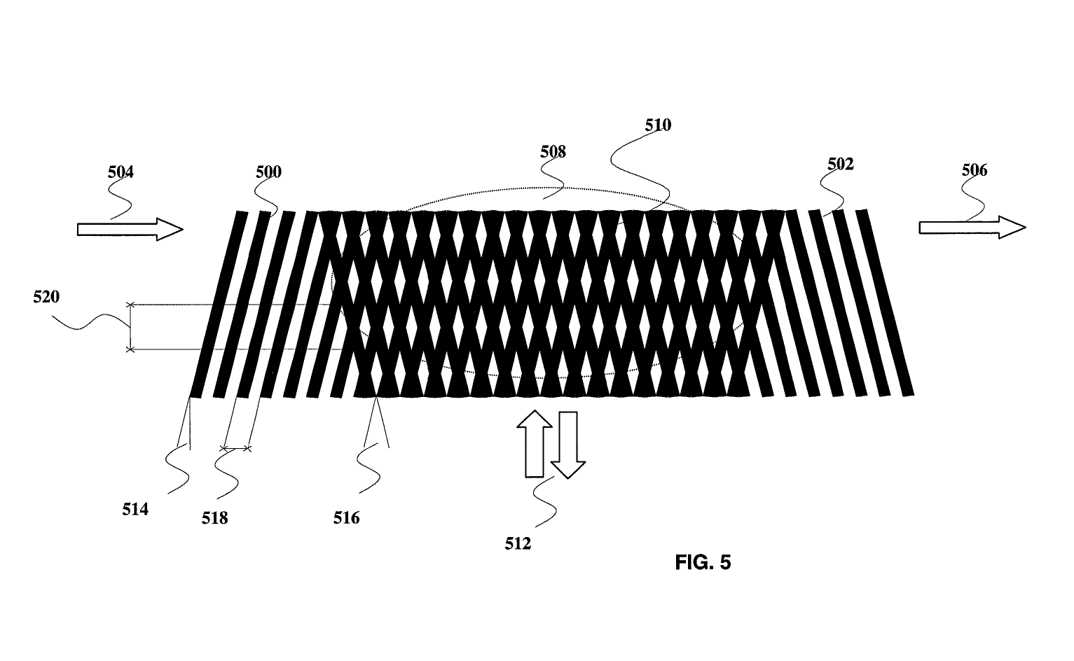

FIG. 5 depicts a diagram illustrating the formation of Moirè fringes in accordance with a preferred embodiment of the present invention. The image of the bar code 500 from disk one interacts with the image of the bar code 502 from another disk to form Moirè fringes 510 in the region 508 where the two images overlap. The width of one line of bar code and the transparent area of bar code is the pitch “p” of the bar code 500 as represented by 518. The lines of the bar codes 500 and 502 interact with each other at a small angle of interaction 516.

The direction of the motion of the images 500 and 502 is represented by arrows 504 and 506, respectively. When the relative motion between 504 and 506 is synchronous, the fringes 510 remain stable (i.e motionless). When the relative motion between 504 and 506 is asynchronous, the Moirè fringes begin to move as represented by arrows 512.

The interaction between bar code images 500 and 502 results in the formation of Moirè fringes 510. The fringes form repeating lines and have a pitch Pₘ as represented by 520 in FIG. 5. The mathematical relationship between the pitch of the bar codes and the pitch of the Moirè fringes is represented by the following equation:

$${P}_{m} = \frac{P}{2 Sin ( a / 2 )} \qquad ( Eq . 6 )$$

where

Pₘ is the pitch of Moirè fringes;

P is the pitch of bar codes; and,

a is the angle of interaction.

As a further enhancement of the concepts discussed above, Moirè fringes can also be observed by mismatch when there is a slight difference in the pitch between the two bar codes 500 and 502. The resulting Moirè fringes are represented by the following equation:

Pₘ=(P₁*P₂)/(P₂−P₁). (Eq. 7)

where

Pₘ is the pitch of the Moirè fringes; and

P₁ and P₂ respectively represent the non-identical pitches of the bar codes 500 and 502.

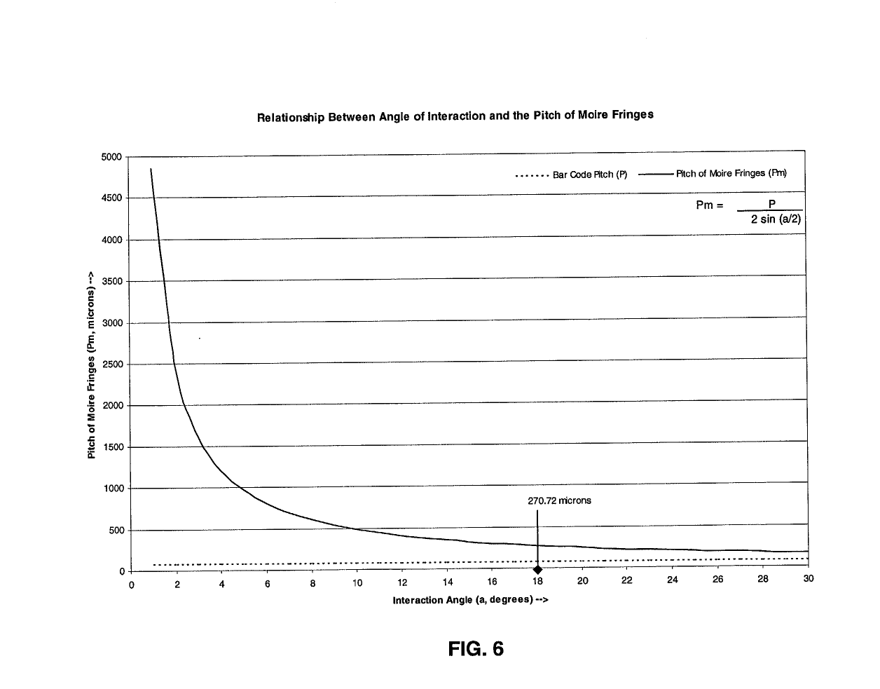

FIG. 6 illustrates a graphical representation of the relationship between the angle of interaction and the pitch of the Moirè fringes. The Moirè effect amplifies the shift dimension by a factor of Pₘ/P, where P and Pₘ are the pitches of the scale and the Moirè fringes. The graph in FIG. 6 shows the pitch of the Moirè fringes as a function of the angle of interaction. If the angle of interaction is, for example, 18°, and two identical bar codes of 300 lines per inch, i.e., at a pitch of 85 microns, are used, then the pitch of the resulting Moirè fringes would be 271 microns. The shift dimension is represented as follows:

$$S = \frac{{P}_{m}}{P} \qquad ( Eq . 8 )$$

Therefore, for the above example the shift dimension would be 3.2. In other words, the pitch of the Moirè fringes that are formed are 3.2 times greater in pitch than the bar codes. This factor reduces the demand on high-resolution optics and increases the measuring resolution. Additionally, it can be appreciated based on the foregoing that one pitch of movement in the bar code can result in one pitch of movement in the Moirè fringes.

As illustrated in FIG. 6, the pitch of the Moirè fringes Pₘ increases as the angle of interaction, a, decreases. Those skilled in the art can appreciate that the sensitivity and resolution of measurement of the device improves as the value of the angle of interaction decreases. This is because the smaller the angle of interaction, the greater the magnification of the pitch of the Moirè fringes. However, at extremely small angles of interaction, the device is also extremely sensitive to any deviations from the predetermined (i.e., by virtue of the design of the device) angle of interaction. Small deviations in the angle of interaction are easily introduced by unavoidable conditions, such as vibrations or slight misalignment of the rotating disks, thereby causing unacceptably large errors in the measurement of relative torque. Therefore, the benefits of high resolution and sensitivity should be weighed against the reliability, economy and robustness of the device.

As is evident in FIG. 6, at larger angles of interaction, the size of the Moirè fringes is relatively smaller. However, even at larger angles of interaction (e.g., 18°) the magnification of the Moirè fringes may be sufficient for easy detection. Additionally, as depicted in FIG. 6, the curve is relatively flat at larger angles of interaction, indicating that the size of the Moirè fringes remains relatively stable over small changes in the angle of interaction. Therefore, the adverse effects due to anomalies introduced by vibration or slight misalignment between the disks can be overcome by designing an embodiment of the present invention with an appropriate angle of interaction while preserving the required sensitivity, reliability and cost of the device.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the spirit and scope of the following claims. It is contemplated that the use of the present invention can involve components having different characteristics. It is intended that the scope of the present invention be defined by the claims appended hereto, giving full cognizance to equivalents in all respects.

The embodiments of an invention in which an exclusive property or right is claimed are defined as follows:

1. A method for analyzing the performance of a system wherein light is directed from at least one light source to an encoded portion of a rotating member of said system, said method comprising the steps of:
transmitting a portion of the light to said encoded portion of said rotating member;
detecting a transmitted portion of the light; and
recovering information from said transmitted portion of the light containing performance characteristic data of said system.

2. The method of claim 1 further comprising the step of:
configuring said light source as a Vertical Cavity Surface Emitting Laser (VCSEL).

3. The method of claim 1 wherein said encoded portion of said rotating member comprises a bar code.

4. The method of claim 1 wherein said encoded portion of said rotating member comprises at least one measuring feature formed on a planar surface of said rotating member.

5. The method of claim 4 wherein said at least one measuring feature formed on said planar surface of said rotating member comprises an optical encoder for encoding performance characteristic data of the system.

6. The method of claim 5 further comprising the step of:
configuring a plurality of measuring features to form a vernier for measuring movement within the system.

7. The method of claim 1 further comprising the step of:
shaping said encoded portion of said rotating member to increase transmission of said transmitted light in a particular direction.

8. The method of claim 1 further comprising the step of:
transmitting at least one light beam from said encoded portions of said rotating member to interact with at least one other light beam to form Moirè fringes on a sensor.

9. The method of claim 1 further comprising the step of:
assessing said system utilizing said performance characteristic data.

10. The method of claim 9 further comprising the step of:
generating an electrical feedback signal from information recovered from said transmitted portion of the light; and
providing said electrical feedback signal to an input of said system, thereby improving said performance characteristic data of said system.

11. An apparatus for analyzing the performance of a system having a rotating member therein, said apparatus comprising:
at least one directing element that directs light from a light source in order to intercept an encoded portion of said rotating member;
at least one transmitting element that transmits a transmitted portion of said light from said encoded portion of said rotating member; and
at least one detector that detects the transmitted portion of said light to recover performance information maintained therein, wherein said performance information contains performance characteristics of said system.

12. The apparatus of claim 11 further comprising:
recovery mechanism that recovers information about a performance characteristic of said system.

13. The apparatus of claim 11 further comprising a second rotating member with an encoded portion affixed thereto and wherein the detector detects a plurality of Moirè fringes formed as a result of the interaction of images from said encoded portions of said rotating member and said second rotating member.

14. The apparatus of claim 11 wherein the directing element comprises an optical lens.

15. The apparatus of claim 11 wherein said light source comprises a vertical cavity surface emitting laser (VCSEL).

16. The apparatus of claim 11 wherein said encoded portion of said rotating member comprises a bar code.

17. An apparatus for detecting the relative motion between at least two rotating members in a system having a light source for generating a light beam, said apparatus comprising:
transmissive mechanism located on a first rotating member for the transmission of said light beam from an encoded portion of said first rotating member;
transmissive mechanism located on a second rotating member for the transmission of said light beam through said encoded portion of said first rotating member; and
a detector for detecting Moirè fringes formed as a result of the interaction of images from said first and second encoded portions of said first and second rotating members, wherein said detection mechanism is located proximate to said system.

18. The apparatus of claim 17 further comprising:
a sensor for analyzing a signal from said detection mechanism, thereby monitoring the motion of said Moirè fringes, wherein said sensing mechanism is located proximate to said system.

19. The apparatus of claim 18 further comprising:
a collimating lens located proximate said system, wherein said collimating lens renders said light beam from said light source into a highly collimated parallel light beam, thereby directing said light beam to intercept said encoded portion on said first rotating member.

20. The apparatus of claim 17 wherein said light source comprises at least one vertical cavity surface emitting laser (VCSEL).

21. The apparatus of claim 17 wherein at least one light beam from said VCSEL is rendered highly collimated by a convex collimating lens before said at least one light beam intercepts at least one encoded portion of said first and second rotating members.

22. The apparatus of claim 21 wherein said at least one encoded portion comprises:
a transparent polymer film having parallel lines of opaque bar code imprinted on an upper surface of said transparent polymer film; and
wherein said opaque parallel lines are spaced evenly with a width of a gap formed therebetween, wherein the width of the gap corresponds to the width of said opaque parallel lines; and
wherein said transparent polymer film is fixed to a rotating member.

23. The apparatus of claim 22 wherein:
said transparent polymer film comprises a bar code when adhered to a rotating disk; and
wherein said bar code is adhered to a planar surface of a rotating member.

24. The apparatus of claim 23 wherein:
said light beam intercepts said first and second encoded portions of said rotating members at an angle of incidence of about 90°; and
wherein said light beam carries an image of said bar code after being transmitted through said encoded portions of said first and second rotating members.

25. The apparatus of claim 22 wherein an image from said first encoded surface interacts with an image of said second encoded surface after said light beam is transmitted through said second rotating surface to produce Moirè fringes.

26. The apparatus of claim 22 wherein Moirè fringes are observed on a sensor.

27. The apparatus in claim 26 wherein said sensor is located at a Talbot distance from a point where said light beam exits a bottom of said encoded surface of said second rotating member.

28. The apparatus of claim 17 wherein said detector is located on a sensor.

29. The apparatus in claim 17 wherein said encoded portion of the first rotating member is shaped to increase said transmitted light in a particular direction.

30. The apparatus of claim 17 wherein said encoded portion of the first rotating member is shaped to form an optical encoder for encoding information representing performance characteristics of said system.

31. The apparatus of claim 17 wherein said encoded portion of the first rotating member is provided as a vernier on said rotating member to increase accuracy for sensing motion thereof.

32. The apparatus of claim 17 wherein said encoded portion of the first rotating member comprises features recessed into a surface or edge of said rotating member.
